(19) United States
(12) Patent Application Publication
(10) Pub. No.: US 2002/0107972 A1
(43) Pub. Date: Aug. 8, 2002

(54) System and method for distributing media content

(76) Inventor: Kerry C. Keane, New York, NY (US)

Correspondence Address: Eugene C. Rzucidlo, INTELLECTUAL PROPERTY GROUP, GREENBERG TRAURIG, LLP, 885 Third Avenue, 21st Floor, New York, NY, 10022, US

(21) Appl. No.: 09/956,320

(22) Filed: Sep. 19, 2001

Related U.S. Application Data
(60) Provisional application No. 60/233,763, filed on Sep. 19, 2000.

(51) Int. Cl. G06F 15/16

(52) U.S. Cl. 709/231; 709/203

(57) ABSTRACT

The present invention discloses a system and method for creating and distributing entertainment media to consumers. Content is distributed on a web page through wired and wireless communication channels. The content may be used purely for the user's exploitation, or may be part of a marketing scheme where promotional material is provided to a user for interacting with the content. Furthermore, data collected from users interacting with the content may be used for marketing analysis.

### CROSS-REFERENCE TO RELATED APPLICATION

This application claims priority from U.S. provisional patent application No. 60/233,763, filed Sep. 19, 2000, the disclosure of which is incorporated herein by reference in its entirety.

### FIELD OF THE INVENTION

This invention relates generally to a system and method for creating and distributing media to consumers. In particular, the instant system and method is utilized by commercial websites to assist in attracting, informing and amusing website visitors, as well as providing consumer incentives which facilitate the process of turning website visitors into customers. Content is distributed on a web page through wired and wireless communication channels. The content may be used purely for the user's exploitation, or may be part of a marketing scheme where promotional material is provided to a user for interacting with the content. Furthermore, data collected from users interacting with the content may be used for marketing analysis.

### BACKGROUND OF THE INVENTION

Attracting visitors to commercial websites is an expensive endeavor, requiring e-businesses to embark on massive traditional and online marketing efforts. Given the proliferation of websites, the challenge of enticing visitors is becoming even more daunting. Even when customers are attracted to a particular website, customer retention, and the prevention of “click through” vendor browsing have become genuine and expensive problems. This competition has led to an extremely high cost for customer acquisition, and has caused e-businesses to seek new methods for customer preservation.

There are several key issues that current e-businesses must face on the highly competitive e-commerce landscape. First, the cost of visitor acquisition remains very high. McKinsey consulting recently reported that the average customer acquisition cost for web-based business exceeded $250 per customer or client. Stock brokerage firms are the top spenders when it comes to visitor acquisition, spending on average between $200 and $400 per client. Travel websites follow a close second, at $150-200 per client, while music, book and toy sites, although typically the lowest spenders, still spend considerable sums at $10-$100 per client. Given these high costs of attracting visitors, and even higher costs of actually acquiring customers, websites are closely examining how best to convert a greater percentage of unique, one-time visitors into repeat customers as the key to generating increased sales and revenue margins.

Another key issue that e-businesses must face is the continued decline in effectiveness of online banner advertisements. Banner advertisements appear as an advertisement displayed on a web page. A Banner Advertisement is typically a graphic, usually an animated GIF image, hyperlinked to the URL of the advertiser. When a visitor clicks their mouse on a banner advertisement, they are transferred to the advertiser's website. The number of responses to a banner advertisement is sometimes refereed to as the number of “clicks” or “click throughs”. The Click-Through Rate (CTR) is defined as the percentage of click throughs to banner views. A 1% CTR means that 1% of each 1000 banner views (or 10 visitors) have clicked through.

Click through rates are dropping sharply. Just three years ago, CTR's were averaging as high as 1.5% to 2.0%. Currently, this average has dropped to just 0.20% to 0.25%. An advertiser with a CTR of 0.50% is now considered to be running an “extremely successful” campaign. In fact, Nielson Net Ratings™, an online market research firm, found that the consumer response rate for banner advertising during February 2000 had declined to 0.23%.

Several compelling reasons have been attributed to this sharp decline in the effectiveness of banner advertisements, including: too many advertisements are chasing too few viewers; the thrill associated with banner advertisements is gone; website clutter has let to an over-saturation of content for the user; and users are more discriminating.

In addition, earlier banner advertising has been rationalized for its website “branding” value. However, recent studies conducted by Market Facts Telenation and others, suggest that over 90% of web users now ignore banner ads. The most basic, cognitive issue proven by eye-tracking studies is that after having been online for more than a couple of months, people visiting the same web page unconsciously don't look at banners. Traditional print and television marketing efforts are suffering from similar over-saturation and consumer apathy.

Another key issue that e-business must face is that website branding and differentiation is becoming increasingly difficult. The Software Consortium, in tandem with Network Wizards, indicated there are approximately 72 million web-sites on the Internet. Of this total, there are approximately 5 million “professionally operated” web-sites (defined as non-personal web-sites including, but not limited to, commercial sites, informational sites and educational sites). A paramount concern for professionally operated websites is attracting and retaining visitors to their venues.

Considering the amount of capital outlay required to acquire a website visitor, the problems of online and traditional advertising, and the sheer number of competitive websites, business are now focusing on how to retain visitors and customers. Each and every visitor represents a substantial investment. Retention of customers is essential for any e-business to survive, to increase market share, and to maximize the long-term economic viability of their Internet venues.

What is needed is a simple and inexpensive system and method for e-business websites to attract and retain users.

### SUMMARY OF THE INVENTION

The present invention discloses a client server system for distributing media to a user. The client server system comprises several components, including a local storage device, a media server, a media refresher, and a media updater.

The local storage device is adapted to store a set of media, such as a set of questions. The media server is operatively connected to the local storage device and adapted to format and present the set of media to a remote user.

The media refresher is operatively connected to a remote storage device and adapted to request new sets of media from the remote storage device upon the expiration of a predetermined period. The period may be for example, an hour, half day, day, week or month, etc.

The media updater is operatively connected to the remote storage device and the local storage device. The media updater is adapted to receive the new set of media and save the new set of media in the local storage device.

The present invention further discloses a method of distributing media to a user over a network. The method comprises the steps of installing an applet on a client server device, the client server device being operatively connected to a local storage device. The applet periodically pulls media from a remote storage device and transmits the media over a network to the local storage device. The media may be, for example, a set of trivia questions. The media is stored on the local storage device. When the applet is activated, the activation causes the applet to transmit the media from the local storage device to the user.

### BRIEF DESCRIPTION OF THE DRAWINGS

FIG. 1 illustrates the components comprising the entertainment system according to one embodiment of the present invention.

FIG. 2 shows a block diagram illustrating the entertainment server 100 according to one embodiment of the present invention.

FIG. 3 shows the registration and applet institution process according to one embodiment of the present invention.

FIG. 4A shows a system level block diagram of a typical client e-business server 115, including the applet code, according to one embodiment of the present invention.

FIG. 4B shows a system level block diagram of relationship between the various modules comprising the client administration unit 410 according to one embodiment of the invention.

FIG. 5 shows a flow chart illustrating the steps to play a trivia game according to one embodiment of the present invention.

### DETAILED DESCRIPTION OF THE INVENTION

The ability of e-business websites to attract and retain users is based, in large part, on their capacity to provide visitors with fresh value-added content. High quality content is the primary reason users return to their favorite sites. In order to attract traffic and maximize “stickiness,” i.e. the time spent by users at sites, web-based companies need to obtain high intensity content and integrate it into their website aesthetics. Interactive entertainment features represent a critical means to achieving what is currently so elusive on the Internet, i.e. website differentiation.

Interactive content such as Game Shows are among the most popular and long-lived programs on television in both the United States and worldwide. They were among the first entertainment formats to be successfully adapted to television from radio, and are consistently among the most popular syndicated television programs.

Trivia Contests are particularly well suited for online entertainment content, especially with the development of higher bandwidth distribution channels, and channels that can be adapted to both the Internet and to wireless devices. Online games and trivia contests are a compelling entertainment medium for a broad user audience because they have a universally understandable multiple choice game-play; allow users to access entertaining content according to their own topical preferences; enable users to participate interactively in the games; and provide users with an opportunity to win prizes.

Internet-based entertainment is among the most “sticky” and compelling types of content available. According to recent reports, there were in excess of 38 million online gamers at the end of 1999, with the expectation that this figure will grow to 68 million by 2003, positioning the online interactive game market for strong future revenue growth. Well-designed entertainment venues have the threefold effect of drawing visitors; retaining users for longer periods of time; and insuring return visits and consumer affinity.

E-businesses have traditionally faced two costly and time consuming alternatives in attempting to obtain and integrate compelling content—either to produce the content themselves or to out-source content from multiple independent contractors. E-businesses that choose to create their own interactive entertainment content face the very high cost of maintaining a full interactive content design and development team, and are severely limited by the volume and breadth of the content they can produce. E-businesses that choose to integrate third party content have limited options and all include manual integrations, little to no customization, and involve significant time, effort and resources at a high cost, in order to obtain a sufficient array of content.

The present invention enables an e-business to seamlessly plug in selections from a content menu into a web page, allowing the e-business to offer its users a chance to play customized trivia contests and games while they remain at the e-business's website. This allows the e-business to offer innovative and customizable interactive and unique “sticky” content that differentiates itself from content displayed at other e-business websites while, all the content is managed, maintained and served by a provider or syndicator. In addition, the present invention make it easy for an e-business to rapidly deploy customized versions of games, offering the e-business's users a unique and personalized experience. Further the present invention may boost the e-business's branding and revenues by allowing customizable advertisements featuring the e-business's sponsors, and by allowing the e-business to “private label” the external and internal graphical elements of the gaming applications to promote their own products, services and partners.

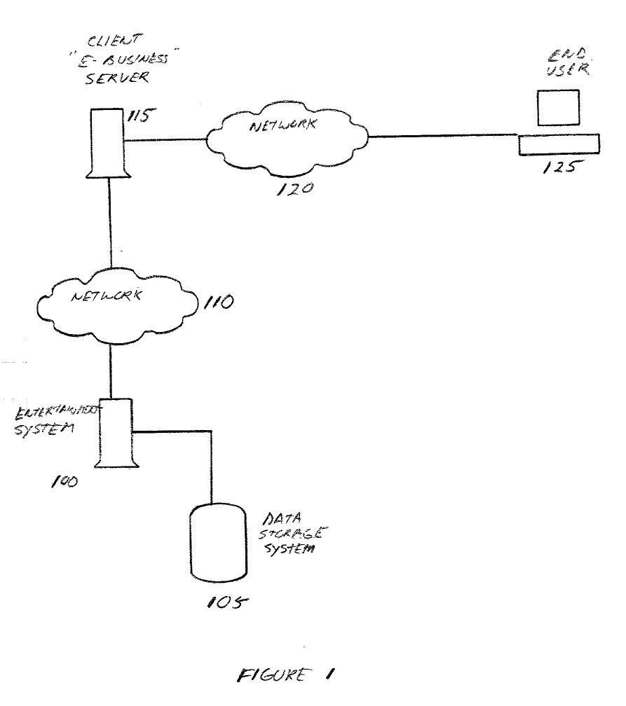

The components of the entertainment system according to one embodiment of the present invention are shown in FIG. 1.

Entertainment system 100 is a server computer system comprising a server hardware and software that provide some services for client computers 115, connected to it via a network 110. One such service is that of a file server. Accordingly, the entertainment system 100 is operatively connected to a local storage disk, i.e. data storage system 105 and services requests from the remote clients 115 to read and write files on that data storage system 105.

The networks 110 and 120 may be any network that is known in the art, and includes any system that transmits any combination of voice, video and/or data between users. The networks 110, 120 includes the network operating system in the client and server machines, the cables connecting them and all supporting hardware in between such as bridges, routers and switches. In wireless systems, antennas and towers are also part of the network. In a preferred embodiment of the invention, the networks 110, 120 are the Internet.

Similar to entertainment system 100, client e-business server 115 is a server computer system comprising a server hardware and software that provide services for end users 125, connected to it via a network 120. In a preferred embodiment, client e-business server 115 is a web server running at a website which sends out web pages in response to Hypertext Transfer Protocol (HTTP) requests from remote browsers. Client e-business server 115 also interacts with entertainment system 100 as described earlier, by virtue of a customized applet (not shown) residing on the client e-business server 115.

The end user 125 is a client browser that transmits requests to client e-business server 115 over network 120, and receives data in response thereto. In a preferred embodiment, the end user 125 is a web browser an the client e-business server 115 is a web server. A web browser communicates with a web server via the TCP/IP protocol. The browser sends HTTP requests to the server, which responds with Hypertext Markup Language (HTML) pages and possibly additional programs in the form of ActiveX controls or Java applets. The end user 125 browser gives some means of viewing the contents of nodes (or “HTML pages”) and of navigating from one node to another.

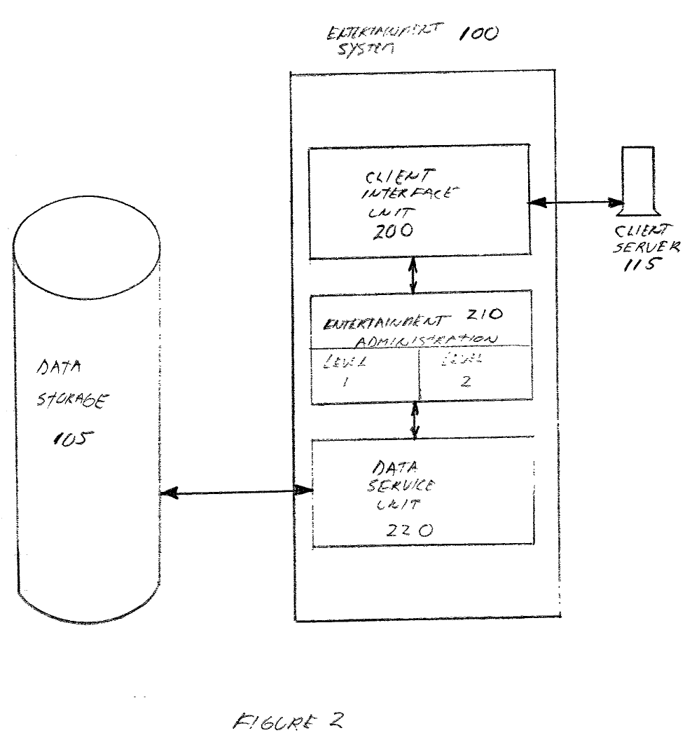

A block diagram illustrating the entertainment server 100 according to one embodiment of the invention is shown in FIG. 2. FIG. 2 also shown the data storage system 105 and the client server 115.

The data storage system 105 stores information for the entertainment server 100. In one embodiment of the invention, the data storage system 105 provides archival storage of the entertainment question and answers for the entertainment game, as well as client information and user information for each game participant. The data storage system can be any database server software, such as ORACLE, SQL Server, etc., running on a server computer.

The entertainment system 100 has a multi-tear architecture comprising client interface unit 200, entertainment administration unit 210, and data service unit 220.

The client interface unit 200 is adapted to connect to the client server unit 115. The client interface unit 200 is an input/output device operatively connected to the entertainment system server 100 and may comprises a Hyper Text Markup Language (HTML) Internet browser. In such configurations, the connection between the client interface unit 200 and the client server 115 is the Internet.

In one embodiment of the invention, the client interface unit 200 is a MOdulator-DEModulator (modem) that adapts a terminal or computer to an analog telephone line by converting digital pulses to audio frequencies and vice versa. In another embodiment of the invention, the client interface unit 200 is a terminal adapter that that adapts a computer to a digital ISDN, cable or DSL line.

The client may access the entertainment system 100 via the client interfaced unit 200 through a network to, for example, pull a series of trivia questions for play by their users; set the number of trivia questions, set the promotional code and scoring percentage required for receiving the promotional code; export the e-mail and zip code of users to downloadable files; turn the client's e-mail confirmation going out to users on or off; and change the confirmation e-mail message that goes out to user getting the promotional code. The client may also retrieve advertising solicitations and marketing materials from the entertainment system. The use of the Internet as network in this matter is well known in the art.

The entertainment system 100 also comprises the entertainment administration unit 210. The entertainment administration unit 210 is a transaction server operatively connected to the client interface unit 200. The entertainment administration unit 210 implements the logical operations of the entertainment system 100.

In one embodiment of the invention, the entertainment administration unit 210 is divided into two distinct back-end administrative level components—Level 1, which will be accessed by the entertainment system 100 personal, and Level 2, which will be used by clients to customize several of the features of the system.

The first administrative level—Level 1—is reserved for the entertainment system 100 personal. This level provides access, via a secure log-in feature and is used to customize the components of the entertainment system 100. Some examples of the logical operations include: adding, removing and editing new clients and clients' settings, i.e. client name, directory address etc.; viewing and exporting user (player) records for all clients in the database; maintenance of generic privacy policy statements; add, delete and/or modify questions in the database; and application operation.

The second administrative level—Level 2—allows the clients to customize several features of the entertainment system 100 for their use. In one embodiment of the invention, the clients will have the ability to: define the game preferences, including setting the number of questions the user will be asked, and setting the promotional code and scoring percentage required for receiving the promotional code; track the results of the users; build the e-mail confirmation message and exporting the e-mail and zip code of users to the client's downloadable files; view and copy the necessary code for operation of the entertainment system; running a test of the entertainment game; and uploading customized graphics to help match the aesthetic of the system with that of the client's website.

To achieve the desired functionality, one embodiment of the Level 2 administrative component is comprised of 6 sections: a preferences section; a view records section; an e-mail confirmation section; a button code section; an upload images section; and a test run section.

The “Preferences” section is designed to set criteria, such as the number of entertainment or trivia questions to present to each user, the quota or threshold limit or correct answers given by the user to qualify for a prize and/or promotional item, the type and number of promotional item(s) to be offered or dispensed to the user, and a toggle to send or not to send an e-mail confirmation.

The “View Records” section allows the client to track and harvest data from game participants. In one embodiment of the invention, data, such as e-mail, zip code, score outcome (win/lose) and date, are recorded and made available for download. The records can then be brought into a spreadsheet or database application for additional data manipulation.

The “E-mail Confirmation” section allows the client to customize the e-mail message that the participating users will receive after playing the entertainment game. In one embodiment of the invention, clients can change the e-mail address, the subject and the body, as necessary. Additionally, the promotion code can be included in the e-mail, and set up as a variable to allow for continuous change. This configuration may be desirable to clients, since the e-mail will not have to be updated each time the promotion code is changed. An example of an e-mail could be:

Dear Quiz Winner:
CONGRATULATIONS! YOU'VE QUALIFIED FOR A
COMPLIMENTARY:
Neighborhood Home Sales Analysis Report . . .
YOUR PROMOTIONAL COUPON CODE IS: QAF4R
HOW TO REDEEM YOUR COUPON:
1. Go to Clientsite.com or call us at 800-555-

2222.

2. Select the Licensed Salesperson you would like

to assist you in finding and/or marketing your
home.

3. When you have decided on one of our Agents,

please inform them of your promotional code
(detailed above).

4. If you have any questions concerning your

coupon, you can call our toll-free number at
800-555-222. We will be glad to help!

TERMS AND CONDITIONS
1. This coupon is valid through 11:59 PM on

January 5, 2001.

2. Limit 1 use of this coupon per household.

The “Button Code” section initiates the transmission of the code from the entertainment system 100 server to the client server 115. The client inserts this code into their website to enable the entertainment system.

The “Upload Images” section enables the client to customize the entertainment application's graphical interface to seamlessly integrate the images and appearance of the Applet into the host site's aesthetics.

“Test Run” section allows the client to run a simulation of the game. The client can utilize this feature to view the customized changes recently made or to view the game before deploying it.

The entertainment administration unit 210 is also operatively connected to a data service unit 220, which is also part of the entertainment system 100. The data service unit 220 provides a connectively layer between the client administration unit 210 and the data storage system 105.

One of the first steps required to commence operation of the entertainment media distribution system is for a client to register as a user, and receive the necessary applet or code to operate within the system. There are numerous methods that can be employed to initiate the registration process, all of which are well known in the art. For example, the potential client may complete an application and transmit the application to the entertainment system operator to register. Once registered, the entertainment system operator may transmit the necessary code to the client for inclusion on the client's website. This may be done manually, as with the completion of a hard copy application and transmission via the mail, or electronically over a network, such as the Internet.

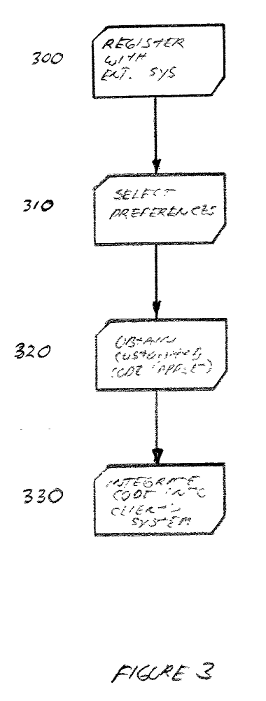

The registration and institution process according to one embodiment of the invention is shown in FIG. 3. In a preferred embodiment, the client applies to the entertainment system operator by first accessing a website associated with the entertainment system operator, and then completing the application process online as shown in step 300. During the application process, the client may select his or her preferences for level 2 functionality as shown in step 310. As described earlier, this may include, for example, selection of the button code; customization of the applications graphical interface; selection of the type of game and game preferences, such as the number of questions to present to a user, the threshold limit of correct answers to become a winner, and the type and number of promotional items. The client may also select or compose the e-mail confirmation that users will receive when successfully competing a game.

Once the client's preferences are selected, the client's customized code or applet may be transmitted to the client as shown in step 320. The customized applet contains all the code for the entertainment system to operate on and between the client's e-business server 115 and the entertainment system 100, and includes all the client's preferences selected in step 310.

In a preferred embodiment, the client's customized code is downloaded electronically to the client's e-business server 115 over the network 110 and imbedded on the client's interactive server space, such as the client's Internet web page, wireless web page, Interactive TV page, etc. as shown in step 330.

The customizable code transmitted from the entertainment system to the client contains several modules as described earlier (Level 2 administration) to allow the client to integrate the applet into their web page, and harvest data from the game. In addition, the customizable code placed on the client's e-business server 115 also contains a module to facilitate periodic communication between the client e-business server 115 and the entertainment system 100. This communication may be, for example to transmit or pull new entertainment media from the entertainment system 100 to the client's e-business server 115, and to upload or push data regarding game statistics and players from the client e-business server 115 to the entertainment system 100.

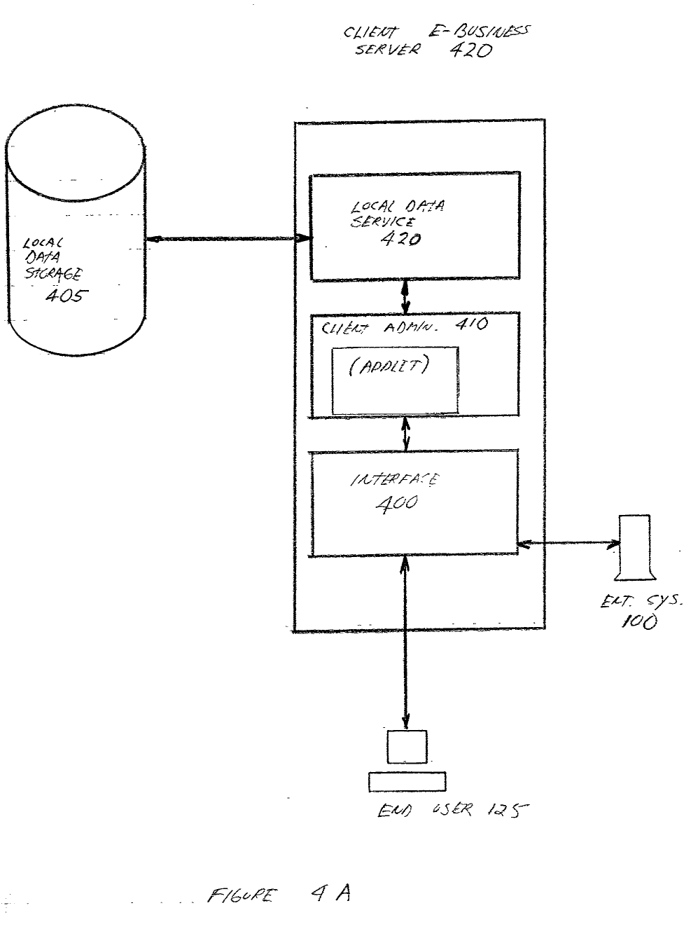

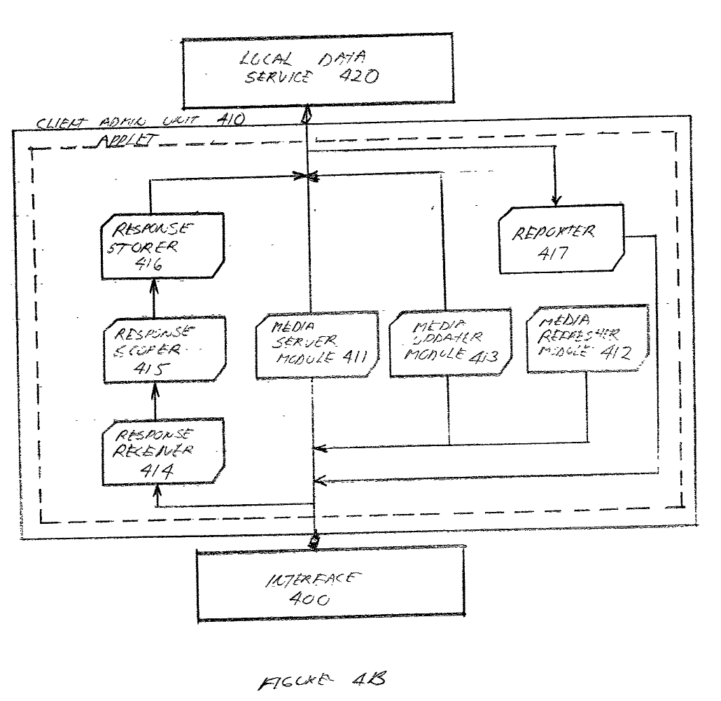

A system level block diagram of a typical client e-business server 115, including the applet code, according to one embodiment of the invention is shown in FIG. 4A.

To facilitate the transmission of data to and from the applet residing on the client's e-business server 115 and the entertainment system server 100, the client e-business server 115 may have a multi-tear architecture. Included in this architecture is the multi-module applet described above. A block diagram illustrating a typical client e-business server 115, including the entertainment applet, according to one embodiment of the invention is shown in FIG. 4.

The local data storage system 405 stores information for the client e-business server 115. In one embodiment of the invention, the local data storage system 405 provides local storage of the entertainment questions and answers for the present period, as well as user and client information for the present period. In other embodiments, the local data storage system 405 may provide storage for other types of informational media as will be apparent to one of skill in the art. The local data storage system can be any database server software, such as ORACLE, SQL Server, etc., running on a server computer.

In one embodiment of the invention, the client e-business server 115 has a multi-tear architecture comprising interface unit 400, client administration unit 410, and local data service unit 420.

The interface unit 400 is adapted to connect to the entertainment system 100 as well as the end user 125. The interface unit is an input/output device, and the connection between the interface unit 400 and the entertainment system 100 and end user 125 is the Internet.

In one embodiment of the invention, the interface unit 400 is a MOdulator-DEModulator (modem) as described earlier. In another embodiment of the invention, interface unit 400 is a terminal adapter that that adapts a computer to a digital ISDN, cable or DSL line.

The client server 115 may, as previously described, access the entertainment system 100 via the interface unit 400 and the client interface 200 through a network to, for example, pull a series of trivia questions for play by their users; set the number of trivia questions, set the promotional code and scoring percentage required for receiving the promotional code; export the e-mail and zip code of users to downloadable files; turn the client's e-mail confirmation going out to users on or off; and change the confirmation e-mail message that goes out to user getting the promotional code. The use of the Internet as network in this matter is well known in the art.

The client e-business server 115 also comprises the client administration unit 410. The client administration unit 410 is a transaction server operatively connected to the interface unit 400. The client administration unit 410 implements the logical operations of the client e-business server 115, and includes the customized applet code provided by the entertainment system to the client. The applet provides the necessary code to periodically instruct the client e-business server 115 to communicate with the entertainment server 100 and pull the entertainment media from the entertainment server 100, while at the same time pushing the data regarding the end user 125 activity to the entertainment server 100. The applet may also provide the instructions to interface with the end user 125.

The client administration unit 410 is also operatively connected to a local data service unit 420, which is also part of the client e-business server 115. The local data service unit 420 provides a connectively layer between the administration unit 410 and the local data storage system 405.

In one embodiment of the invention the client administration unit 410 comprises several different modules, some or all of which may be incorporated into the applet customized code. FIG. 4B shows a block diagram of the client administration unit 410 illustrating the modules according to one embodiment of the invention. The modules may be categorized into two separate but related categories: Media or question side modules and response side modules.

The media side modules concern obtaining and providing media to the user 125. One such module is the media server module 411. The media server module 411 is operatively connected to the local data storage device 405 through the local data service 420, and adapted to format and present the game questions to the user 125 through interface 400.

A media refresher module 412 is also provided and is operatively connected to the remote data storage device 105 through interface 400 and entertainment system 100. The media refresher module 412 is adapted to request new questions from the remote data storage device 105 upon the expiration of a predetermined period.

A media updater module 413 is also provided and is operatively connected to the remote data storage device 105 and local data storage device 405 through interface 400 and local data service 420 respectively. The media updater 413 is adapted to receive the new set of questions requested by the media refresher 412, and save the new set of media in the local data storage device 405.

The response side of the client administration unit 410 includes the following modules: a response receiver module 414; a response scorer module 415; and response storer module 416; and a reporter 417.

The response receiver 414 is operatively connected to the end user 125 through interface 400, and is adapted to receive a user response to the question presented to the end user 125.

The response scorer 415, the response scorer operatively connected to the response receiver, and adapted to evaluate the user response to the questions presented. This evaluation may include, for example, determining if the question is correctly or incorrectly answered, and tallying the cumulative results during the interactive session.

The response storer module 416 is operatively connected to the response scorer 415 and the local data storage device 405. The connection between the response storer module 416 and the local data storage device 405 is through local data service 420. The response storer 416 is adapted to receive the evaluation of the user response and store the evaluation to the local data storage device 405. The client administration unit 410 also comprises a reporter module 417 for reporting the results of the evaluated user 125 response from the local data storage device 405 to the remote data storage device 105.

In operation, the client's customized code, i.e. the applet, residing on the administration level 410 of the client's e-business server 115 periodically instructs the client server 115 to contact the entertainment server 100. This connection is established through interface 400.

The period between connections may be determined by the client, and may be, for example every day (24 hours). A clock mechanism may be used to track and determine when the period has expired and the connection should be established. In one embodiment of the invention, the clock mechanism resides in the client administration unit 410.

Once the connection is established, the applet communicates with an application resident on the entertainment system 100 and pulls new entertainment content from the entertainment system 100. Once received, this information is sent from interface 400, through administration 410 to local data service 420 and saved on the local data storage 405. Similarly, the applet residing in the client e-business server 115 retrieves data resident on the local data storage 405 through the local data server 420, and pushes the data through the interface 400 to the entertainment system 100. This data may include, for example, the data harvested from the entertainment game participants, i.e. users 125, and includes such information as the end user's 125 e-mail, zip code, score outcome (win/lose) and date of activity. A handshaking protocol, as is well know in the art, ensures the transmission to/from the entertainment system server 100 is complete.

The period or interval between communications from the client e-business server 115 to the entertainment system 100 may be determined by several factors, but is generally the “refresh rate” that the client wants to change the entertainment media content. In a preferred embodiment of the invention, new content is pulled by the client e-business server 115 every 24 hours. This ensures that the client's website will have fresh content every day, and that a player can play the game, or enjoy the entertainment media every day.

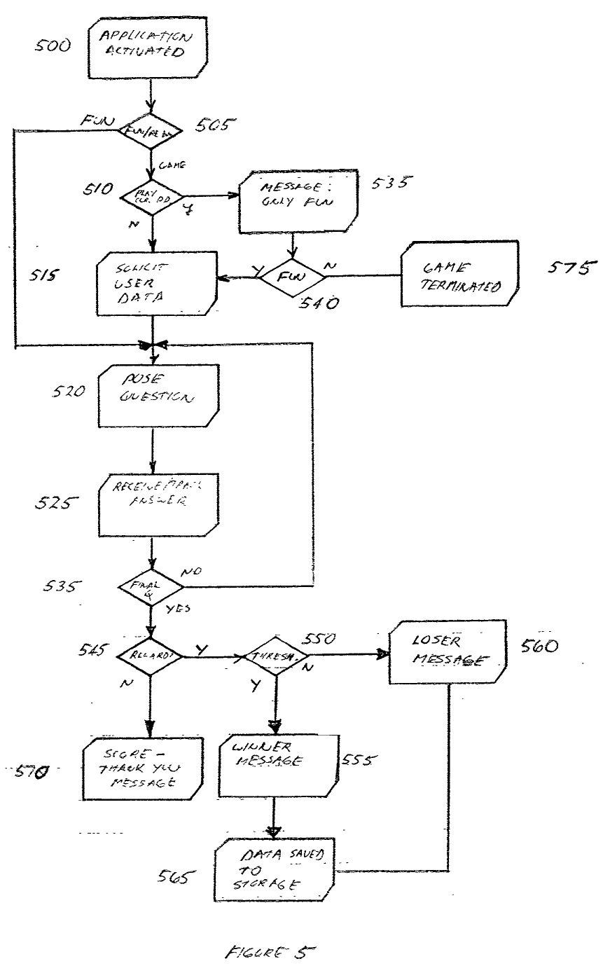

Once the client is registered with the entertainment system and the applet is installed on the client's e-business server 115, the entertainment media or “game” is ready to be used to attract and maintain end users 125 to the client's website. A flow chart illustrating the steps to play a trivia game according to one embodiment of the invention is shown in FIG. 5.

In the embodiment illustrated, the trivia game is comprised of a plurality of trivia questions. The application code or applet on the client's e-business website is activated as shown in step 500. Activation of this code may take place, for example, by the user 125 selecting the “play” button on the client's website which activates the “button code” enabling the trivia contest.

When the trivia game is enabled, a determination is made as to whether the user wishes to play the game for fun, or would like to play for a reward, such as a prize or credit as shown in step 505. Rewards may include, for example, discount coupons off purchases at the client's e-business website, or credits or “points” towards gift items.

If the user 125 wishes to play the game for fun, the applet proceeds to step 520 and a question is posed. If, on the other had, the user 125 wishes to play the trivia game for a reward, a determination is then made as to whether the user 125 has played the game during the current period. If the answer to this query is in the affirmative, the user 125 cannot play the game again for rewards, and an appropriate message is displayed to the user 125 as shown in step 535. The user 125 is then given the option to play the game for fun as shown in step 540, in which case the applet proceeds to step 520 and poses a question. If the user 125 does not wish to play for fun, the applet is terminated as shown in step 575.

If the user 125 has not played the game in the present period, and wishes to play the game for rewards, user data is solicited from the user 125 as shown in step 515. As described earlier, user data may include, for example, the e-mail and zip code of the user 125.

A question is then posed to the user 125 as shown in step 520. In one embodiment of the invention, the question is posed as a multiple choice question with radio buttons soliciting a response from the user 125. The question may be one of a series of questions, as determined by the client's preferences.

The applet tracks the user's 125 answer to the question as shown in step 525. Tracking the user's answer includes determining if the question is answered correctly, and summing the correct responses.

A determination is then made in step 530 as to whether the final question in the series was presented to the user 125. If the answer to the query is in the negative, another question is posed to the user 125 in step 520, and the user's 125 response is tracked in step 525. Alternatively, if the final question is posed, the user's 125 responses are tallied and an appropriate response is transmitted as shown in steps 545 through 570.

To provide the appropriate response, the applet must first revisit the earlier determination as to whether the trivia game was being played for fun or rewards as shown in step 545. If the game was being played for fun, the user's 125 score is tallied and presented with an appropriate message indicating the score as shown in step 570. For example, the user 125 may be notified that the game is over and told to come back and play during the next period.

Conversely, if the game was being played for rewards, it must be determined if the threshold level of correct answers was met as shown in step 550. The threshold level may be determined by the client's preferences as described earlier.

If the threshold level was met, the user 125 is notified that he is a winner as shown in step 555. An appropriate confirming notice will be sent to the user instructing then on the redemption of their reward. In a preferred embodiment of the invention, the notice is in the form of an e-mail message.

If on the other hand, the threshold level was not met, the user 125 is notified that they did not win, and asked to play again during the next period as shown in step 560. The user 125 may also be asked if they wish to play the game for fun.

In either scenario, the user's 125 user data solicited from the user in step 515, as well as the results of the game and any other pertinent data is transmitted to the local data storage 405 through local data service 420 as shown in step 565.

It will be immediately apparent to those skilled in the art that variations and modifications to the disclosed embodiment are possible without departing from the spirit and scope of the present invention. By way of example the same invention may be used by corporations as a training aide, such as by providing training and/or policy manuals, and follow up questions to employees. In this embodiment, the employee may be asked, for example to read certain sections of a training or policy manual. Periodically, the employee may be asked questions through the companies intranet site relative to the reading assignment. To obtain these questions, the company intranet side may pull questions from the data storage system pertinent to the current period reading assignment. The corporation can track the employees responses to these questions, providing valuable information and proof of the employees knowledge and training for the particular 'subject matter.

The invention is defined by the appended claims.

What is claimed is:

1. A client server system for distributing media to a user, the client server system comprising:
a. a local storage device, the local storage device adapted to store a set of media;
b. a media server, the media server operatively connected to the local storage device, the media server adapted to format and present the set of media to a remote user;
c. a media refresher, the media refresher operatively connected to a remote storage device, the media refresher adapted to request new sets of media from the remote storage device upon the expiration of a predetermined period; and
d. a media updater, the media updater operatively connected to the remote storage device and the local storage device, the media updater adapted to receive the new set of media and save the new set of media in the local storage device.

2. The client server system of claim 1 wherein the media being distributed is in the form of questions.

3. The client server system of claim 1 wherein the local storage device is a magnetic storage device.

4. The client server system of claim 1 wherein the local storage device is an optical storage device.

5. The client server system of claim 1 further comprising:
a. a response receiver, the response receiver operatively connected to the remote user, the response receiver adapted to receive a user response to the media presented to the remote
b. a response scorer, the response scorer operatively connected to the response receiver, the response scorer adapted to evaluate the user response;
c. a response storer, the response storer operatively connected to the response scorer and the local storage device, the response storer adapted to receive the evaluation of the user response and store the evaluation to the local storage device.

6. The client server system of claim 1 further comprising a reporter for reporting the results of the evaluated user response from the local storage device to the remote storage device.

7. A method of distributing media to a user over a network, the method comprising:
a. installing an applet on a client server device, the client server device being operatively connected to a local storage device;
b. the applet periodically pulling media from a remote storage device and transmitting the media over a network to the local storage device;
c. storing the media on the local storage device; and
d. activating the applet on the client server device, the activation causing the applet to transmit the media from the local storage device to the user.

8. The method of claim 7 further comprising the steps of:
a. receiving a response to the media from the user;
b. evaluating the response;
c. storing the evaluation of the response to the local storage device.

9. The method of claims 9 wherein the step of evaluating the response comprises:
a. determining if the response to the media was correct or incorrect; and
b. aggregating the correct and incorrect responses to determine a score.
